(19) United States
(12) Patent Application Publication
(10) Pub. No.: US 2004/0169729 A1
(43) Pub. Date: Sep. 2, 2004

(54) Free-standing photo strip

(76) Inventor: Yefim Massarsky, Newton, MA (US)

Correspondence Address: Brian M. Dingman, Mirick, O'Connell, DeMallie & Lougee, LLP, 1700 West Park Drive, Westborough, MA, 01581, US

(21) Appl. No.: 10/778,511

(22) Filed: Feb. 11, 2004

Related U.S. Application Data
(60) Provisional application No. 60/446,634, filed on Feb. 11, 2003.

(51) Int. Cl. H04N 5/225

(52) U.S. Cl. 348/207.2

(57) ABSTRACT

A self-photograph system that produces a strip having a number of photographs. The system includes a camera for capturing one ore more images of a user, at least one printer for printing one or more captured images, and photographic paper loaded in each of the printers, the paper having one or more weakened fold lines that divide the paper into at least two contiguous print areas, with a captured image printed in at least two such print areas, the printed images arranged on the paper either horizontally or vertically.

### CROSS REFERENCE TO RELATED APPLICATION

This application claims priority of Provisional application serial No. 60/446,634, filed on Feb. 11, 2003.

### FIELD OF THE INVENTION

This invention relates to a photography booth that prints strips of images.

### BACKGROUND OF THE INVENTION

Photography booths are well known. The booths capture one or more images of one or more users located in the booth, and print one or more of those images. Some such booths print a single image, perhaps with additional text or pre-defined background images. Other booths print a strip of photographs one on top of the other, usually three or four to a strip. These strips capture the user in three or four different poses.

However, these strips have limitations that prevent them from being useful in many situations. For one, in order to share the images, the users must cut the strip where desired. Also, there is no means by which the strip can be displayed by itself, without the need for fasteners or the like to fix the strip to another object or surface. In addition, there is nothing of interest or value provided to the user other than the photographs.

### SUMMARY OF THE INVENTION

It is therefore an object of this invention to provide a self-photography system that produces a strip that includes a number of photographs. The strip is designed to be folded along one or more fold lines so that it can be made free-standing. Also, the strip can be divided along these fold lines so that the images and/or other matter printed on the strip can be separated from the strip, for a desired use.

This invention features a self-photograph system that produces a strip comprising a plurality of photographs, the system comprising a camera for capturing one ore more images of a user, at least one printer for printing one or more captured images, and photographic paper loaded in each of the printers, the paper having one or more weakened fold lines that divide the paper into at least two contiguous print areas, with a captured image printed in at least two such print areas, the printed images arranged on the paper either horizontally or vertically. The camera may be a video camera.

The paper may be generally rectangular, with two generally parallel longer length sides, and two generally parallel shorter width sides. The paper may have a long fold line generally parallel to the longer sides of the paper. The long fold line may bisect the paper. The long fold line may be closer to one longer side than it is to the other longer side.

The paper may have at least short fold line generally parallel to the shorter sides of the paper. The paper may have a plurality of short fold lines that divide the paper into print areas that each extend across the width of the paper. The print areas may be divided into separate sub-areas, to provide for the printing of photographs and text in separate sub-areas. There may be three such short fold lines, that divide the paper into four print areas. The four print areas may all be about the same size.

The paper may comprise one or more additional perforated lines in the paper, to provide one or more tear-off areas. The paper may comprise a plurality of spaced shorter fold lines across the width of the paper that create contiguous print areas that are each divided into two sub-areas by the long fold line. A photograph may be printed in one sub-area of each print area.

### BRIEF DESCRIPTION OF THE DRAWINGS

Other objects, features and advantages will occur to those skilled in the art from the following description of the preferred embodiments, and the accompanying drawings in which:

FIG. 1 is a perspective view of one embodiment of a photo strip produced by the system of this invention;

FIG. 2 is a similar view of another embodiment of a strip created by the system of this invention;

FIG. 3 is a perspective view of the strip of FIG. 2 arranged into a cube display; and

FIG. 4 is a schematic block diagram of the key components of a system of this invention.

### DESCRIPTION OF THE PREFERRED EMBODIMENTS

This invention produces a pre-perforated photo strip printed from a photo booth that captures an image of one or more persons sitting in the booth. Such booths are well known, and have many variations to the image type and/or background in which the image is placed.

The perforations of the photo strip of the invention can be arranged horizontally and/or vertically. The two or more images can be arranged side by side horizontally, or vertically, with the images arranged one above another. The images can all be the same or can be different and captured sequentially during a single sitting in the photo booth. The inventive strip is designed to be free-standing by providing one or more fold lines that allow the strip to be easily folded to give some dimensionality to the paper so that it can stand without a frame or other support. The fold line(s) and the perforated line(s) can be different, or can be one and the same.

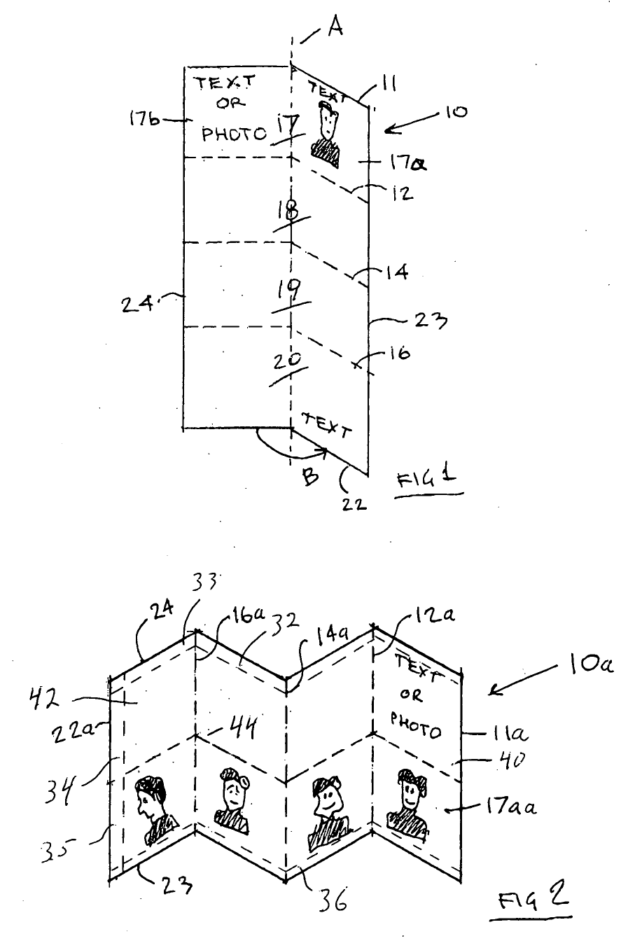

One embodiment of photo strip 10 of this invention is shown in FIG. 1. Strip 10 comprises four images or print areas 17-20. For images or areas that are arranged one on top of another, image sheet 10 defines vertical fold line A that bisects strip 10 and is generally parallel to long sides 23 and 24. Fold line A is preferably accomplished by including micro perforations along line A. In this case, one side of strip 10 would typically carry a plurality of photos, and the other side would carry other text, headings or other user-selected information. For example, a photograph could appear in sub-area 17a of area 17, to the right of fold line A, and text could be placed in sub-area 17b of area 17 to the left of fold line A. In the vertical strip arrangement shown in FIG. 1, the strip can also be easily torn along these fold lines. Strip 10 is folded along line A preferably such that angle B is greater than 90° and less than 180°, so that the photos and text can be easily viewed from the front side while the strip is free-standing.

For a horizontal arrangement (FIG. 2), the images (e.g. in sub-area 17aa) could be rotated 90° to the right or left, depending on which long side was designated as the bottom of the strip. Micro perforations along lines 12a, 14a and 16a would divide paper 10a into four areas, each area extending along the full height of the paper when it is laid on one of sides 23 or 24. The micro perforations (or scoring) along lines 12a, 14a and 16a allow the user to fold the strip in an accordion shape as shown in FIG. 2 so that strip is free-standing. The strip can also be easily tom along these fold lines.

FIG. 2 depicts additional features of the invention that can be included in the photo strip regardless of whether the strip is in the horizontal arrangement of FIG. 2 or the vertical arrangement of FIG. 1. One or more additional fold lines such as lines 32, 36 and 34 can be included to accomplish one or more desired purposes. For one, this additional fold line or fold lines can comprise micro perforations to create smaller tear-off areas such as area 33 bounded by lines 32 and 16a. A coupon or other promotional material can be printed in area 33, for example.

The inventive photo strip can be sized and shaped as desired. Preferably, the strip is printed by an ink-jet printer or similar printer as known in the art adapted to print photo quality prints on photographic quality paper that is readily available from many sources in the market place. Preferably, the paper has a fold line or fold lines pre-defined through micro perforations. This also allows one or more of the print areas or sub-areas to be separated from the strip. This allows the images and/or text to be used apart from the strip.

The invention comprises two or more horizontally or vertically arranged photographic images areas. Preferably, there is text or additional images also printed on the paper as selected by the user. These could take many variations. For example, the user may select a background or overlay of images or text as is well known in the field. In one example of a vertical arrangement such as shown in FIG. 1, there can be four images vertically arranged in the four sub-areas on one side of vertical fold line A, with a caption at the top of the images, with the caption repeated in the four sub-areas along the other side of the fold line. Additionally, a proverb, a set of lucky numbers, or other text or images, either selected by the user or printed on every strip or randomly selected by the computer in the photo booth, can be printed along with the photographs.

It is also possible to have options for the type or arrangement or size of photos and the style in which the photos are printed. For example, it is possible for the user to select a “photo ID” in which only one of the several captured images is printed, and printed multiple times. One or more of the images can then be separated along a perforation line for use in an ID. There could also be the option for printing color photos or black and white photos. In addition, the style of the printing can be varied to evoke an artistic style, such as a color or black and white museum portrait, a nostalgic sepia type image, or classic black and white image. There may also be a choice of slogans such as “best friends”, “I love you”, or “perfect angels”.

The width of the strip can be as desired as accommodated by the printer used. Printers that are adapted to print envelopes have two or more rollers or wheels and a moveable guide to allow printing of an envelope. If desirable for printing a strip that is more narrow than an envelope, the guide can be modified by making it wider so that there is less space between the moveable guide and the fixed printer guide, as long as the strip is taken up by at least one roller or wheel, and preferably two so that there is less risk of the strip being skewed as it moves through the printer. Another alternative to achieve a thin strip would be to make the paper wider, but print on only a portion of the paper and perforate the paper at the edge of the printed portion to allow the non-printed strip of paper to be removed by the user, and thus leave behind a more narrow printed strip.

Preferably, the final product to be printed, with the arrangement of photographic images, text, background, etc., is displayed to the user in the photo booth before it is printed. This allows the user to change one or more of the selected options, for example to print all the images rather than one image multiple times, or change the background, displayed text, etc.

The pre-perforation of the printer paper can be selected to achieve a desired result. For example, the perforations can be arranged so that not all the images are the same size, or the images are sized to fit a particular device. For example, the images could be sized to fit in snap-together key chains that can also be sold at the location, for example in a coin-operated key chain dispenser attached to the photo booth. The printer could also print images that are sized to fit in a booklet that is sold from a vending machine near or attached to the photo booth. These are but two of numerous possibilities.

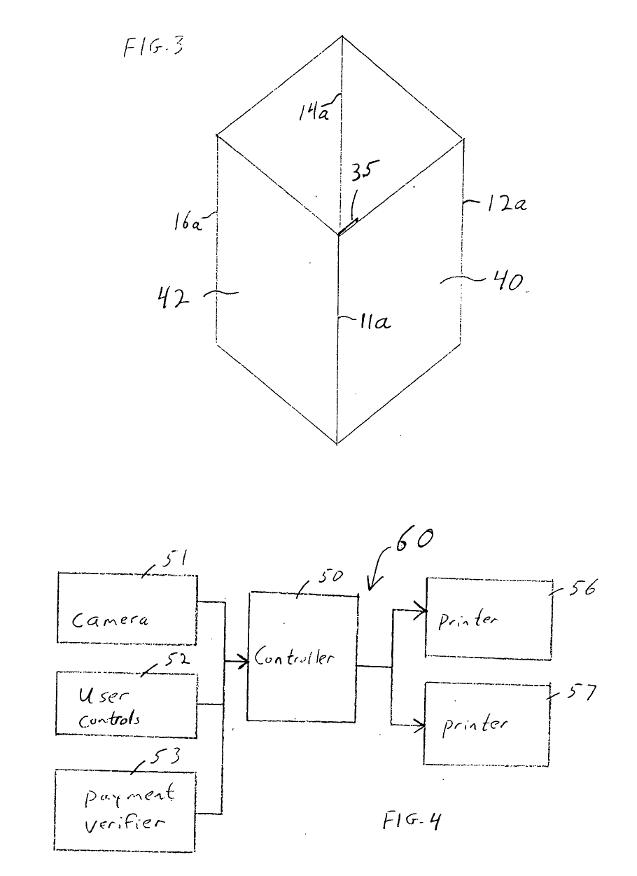

FIG. 3 depicts the strip 10a of FIG. 2 folded into a four-sided shape like a cube with an open top and bottom. This allows the images or other material in each of the four print areas to be displayed on a desk or the like. Also, end area 35 created by fold line 34 can be folded in and overlapped near edge 11a. Tape or an adhesive could be used to affix the strip in the shapes shown in FIG. 3. Alternatively, the paper could have applied to it an adhesive in area 35 for this purpose. The adhesive could be covered with a removable protective backing as is known in the art to both protect the adhesive and also allow the paper to run smoothly through a printer.

A simplified schematic block diagram of a system for this invention is shown in FIG. 4. System 60 includes camera 51 (typically a video camera), user controls 52 and payment verifier 53 that provide relevant inputs to controller 50, which may be accomplished by a programmed computer. System 60 includes at least one printer and potentially more, as depicted by printers 56 and 57. Such systems (but using only one printer) are known per se in the art.

Other embodiments will occur to those skilled in the art and are within the following claims:

What is claimed is:

1. A self-photography system that produces a strip comprising a plurality of photographs, the system comprising:
a camera for capturing one or more images of a user;
at least one printer for printing one or more captured images; and
photographic paper loaded in each of the printers, the paper having one or more weakened fold lines that divide the paper into at least two contiguous print areas, with a captured image printed in at least two such print areas, the printed images arranged on the paper either horizontally or vertically.

2. The self-photography system of claim 1 wherein the camera comprises a video camera.

3. The self-photography system of claim 1, wherein the paper is generally rectangular, with two generally parallel longer length sides, and two generally parallel shorter width sides.

4. The self-photography stems of claim 3, wherein the paper has a long fold line generally parallel to the longer sides of the paper.

5. The self-photography system of claim 4, wherein the long fold line bisects the paper.

6. The self-photography system of claim 4, wherein the long fold line is closer to one longer side than it is to the other longer side.

7. The self-photography system of claim 3, wherein the paper has at least one short fold line generally parallel to the shorter sides of the paper.

8. The self-photography system of claim 7, wherein the paper has a plurality of short fold lines that divide the paper into print areas that each extend across the width of the paper.

9. The self-photography system of claim 8, wherein the print areas are divided into separate sub-areas, to provide for printing in the separate sub-areas.

10. The self-photography system of claim 7, wherein there are three such short fold lines, that divide the paper into four print areas.

11. The self-photography system of claim 10, wherein the four print areas are all about the same size.

12. The self-photography system of claim 1 further comprising one or more additional perforated lines in the paper, to provide one or more tear-off areas.

13. The self-photography system of claim 5 further comprising a plurality of spaced shorter fold lines across the width of the paper that create contiguous print areas that are each divided into two sub-areas by the long fold line.

14. The self-photography system of claim 13, wherein a photograph is printed in one sub-area of each print area.

15. A photo strip printed by a self-photography system that produces a strip comprising a plurality of photographs, the system comprising a camera for capturing one or more images of a user and at least one printer for printing one or more captured images, the strip comprising:
photographic paper printed by one of the printers, the paper having one or more weakened fold lines that divide the paper into at least two contiguous print areas, with a captured image printed in at least two such print areas, the printed images arranged on the paper either horizontally or vertically.

16. The self-photography system of claim 15, wherein the paper is generally rectangular, with two generally parallel longer length sides, and two generally parallel shorter width sides.

17. The self-photography stems of claim 16, wherein the paper has a long fold line generally parallel to the longer sides of the paper.

18. The self-photography system of claim 17, wherein the long fold line bisects the paper.

19. The self-photography system of claim 17, wherein the long fold line is closer to one longer side than it is to the other longer side.

20. The self-photography system of claim 16, wherein the paper has at least one short fold line generally parallel to the shorter sides of the paper.

21. The self-photography system of claim 20, wherein the paper has a plurality of short fold lines that divide the paper into print areas that each extend across the width of the paper.

22. The self-photography system of claim 21, wherein the print areas are divided into separate sub-areas, to provide for printing in the separate sub-areas.

23. The self-photography system of claim 20, wherein there are three such short fold lines, that divide the paper into four print areas.

24. The self-photography system of claim 23, wherein the four print areas are all about the same size.

25. The self-photography system of claim 15 further comprising one or more additional perforated lines in the paper, to provide one or more tear-off areas.

26. The self-photography system of claim 18 further comprising a plurality of spaced shorter fold lines across the width of the paper that create contiguous print areas that are each divided into two sub-areas by the long fold line.

27. The self-photography system of claim 26, wherein a photograph is printed in one sub-area of each print area.
